(19) United States
(12) Patent Application Publication
(10) Pub. No.: US 2015/0254902 A1
(43) Pub. Date: Sep. 10, 2015

(54) BRINGING MAIL TO LIFE VIA MOBILE SYSTEMS AND METHODS

(71) Applicants: Carlos MACIA, La Crescent, MN (US); Shahrom KIANI, Onalaska, WI (US); Christina Dahling KIANI, Onalaska, WI (US); Russell W. GUENTHNER, Glendale, AZ (US)

(72) Inventors: Carlos MACIA, La Crescent, MN (US); Shahrom KIANI, Onalaska, WI (US); Christina Dahling KIANI, Onalaska, WI (US); Russell W. GUENTHNER, Glendale, AZ (US)

(21) Appl. No.: 14/201,377

(22) Filed: Mar. 7, 2014

(51) Int. Cl. G06T 19/00

(52) U.S. Cl. CPC G06T 19/006

(57) ABSTRACT

A method is disclosed for bringing mail to life by providing a personalized multi-media experience using a camera-enabled mobile device to acquire an image stream of a mail piece. The method includes using the mobile device to process the image stream to generate multi-media content and reproduce the content using the mobile device. The method includes using augmented reality or 3D hologram software applications to provide the personalized experience.

This application is a continuation-in-part and claims priority to a U.S. patent application Ser. No. 13/554,041 filed Jul. 20, 2012 titled “POSTAL MAIL TO ELECTRONIC COMMUNICATION AND RELATED METHODS” with first named inventor CANNON Patrick Jerald, La Crosse, Wis. (US), which is expressly incorporated herein as though set forth in full.

### BACKGROUND OF THE INVENTION

Advances in processing power and camera technology in mobile devices have enabled the development of interesting advertising applications using technology such as Quick Response (QR) codes to deliver content to a mobile device after a user scans a QR code from some form of printed media. These applications have helped bridge the gap between the physical and the electronic media. Unfortunately, the type of applications developed to date deliver fairly generic content, essentially redirecting the user to a Web page. Hence, improvements are needed.

### BRIEF SUMMARY OF THE INVENTION

Embodiments of the present invention describe a method of bringing mail to life by providing a personalized multi-media experience to a user or mail recipient. The method includes, for example, a mail recipient using a camera-enabled mobile device to acquire an image stream of a mail piece. The method also includes a mail recipient using the mobile device to process the image stream to generate or obtain the multi-media content and reproduce it using the mobile device.

In certain embodiments, a camera-enabled mobile device such as a smart phone or tablet is used by a recipient of a mail piece such as a letter, postcard, magazine or parcel to acquire and process an image stream of the mail piece to generate or obtain multi-media content using previously downloaded augmented reality software application residing on the recipient's mobile device to reproduce visual data imagery that is not visible on the mail piece. The augmented reality software application may include optical character recognition, pattern recognition, field recognition, or barcode recognition algorithms that determine the sender of the mail piece, the recipient of the mail piece and/or the mail campaign entity or organization. The recipient's personalized multi-media experience may involve the display of visual data imagery on the mobile device that is unique to the mail piece and/or unique to the recipient of the mail piece. The recognition of the sender may be through recognition of the sender's logo or through the recognition of any special markings or through the recognition of the “mailer identifier” field in the Intelligent Mail barcode.

As known in the art, augmented reality (AR) technology provides a view of a physical, real-world environment whose elements are augmented (or supplemented) by computer-generated sensory input such as sound, video, graphics or Global Positioning System (GPS) data. It may optionally include a view of reality which is modified and/or diminished rather than augmented by a computer. Augmented reality technology operates by providing an image stream that when viewed enhances a person's current perception of reality or of an object or view of the world. It may also involve replacing a real world view, in whole or in part, with a simulated one. Augmentation may optionally occur in real-time and/or in context with environmental elements, or current events such as sports scores. With the help of advanced AR technology (that is with a computer adding image analysis and object recognition based upon input data) the information about the surrounding real world of the user can optionally become interactive and can also be digitally manipulated. Artificial information about the environment and its objects can be overlaid on the real world view, or on a virtual image of a recognized view of the world or a specific object.

In other embodiments, the mobile device of the recipient is used to process the image stream to generate or obtain the multi-media content that may include using a previously downloaded three dimensional (3D) hologram software application residing on the mobile device to reproduce a 3D hologram experience for the mail recipient. The 3D hologram software application may include optical character recognition, pattern recognition, field recognition, or barcode recognition algorithms or mechanisms that determine the sender of the mail piece, the recipient of the mail piece or the mail campaign organization or entity. The personalized multi-media experience on the mobile device may include the display of a 3D hologram that is unique to the mail piece and/or unique to the recipient of the mail piece.

As known in the art, 3D Holography is a technique/method which enables three-dimensional images (holograms) to be made and viewed. It may involve the use of a laser, interference, diffraction, light intensity recording and/or suitable illumination such as a laser during such recording. A 3D image, as it is viewed, changes as the position and orientation of the viewing system changes in a way that is similar to the way it would if the object were actually present, thus making the image appear three-dimensional. It will be appreciated that 3D holography projection is a developing art with projection of a 3D image on a mobile device such as a computer “tablet” achieved by using an Imagination Farm USA LLC developed application program called HOLHO. Examples of sample images generated by the program are available from the website located at “http://www.holhocollection.com/”.

Other embodiments describe the use of a computer-readable medium having computer-executable instructions thereon. The instructions are organized or programmed to configure a recipient's mobile device to capture an image stream, process this image stream using optical character recognition, pattern recognition, field recognition, or barcode recognition mechanisms that determine the sender of the mail piece, the recipient of the mail piece or the mail campaign, and display augmented reality visual data imagery or a 3D hologram that are unique to the mail piece and/or the recipient of the mail piece using the mobile device.

In some embodiments, the computer-executable instructions are further implemented or configured on the recipient's mobile device to save the personalized content to be viewed at a later time. Saving the content may involve operations of storing the content on the mobile device's memory or transmitting the content to a server and creating a link to the saved content.

In certain embodiments, the recognition of the sender may be through recognition of the sender's logo or through the recognition of any special markings or through the recognition of the “mailer identifier” field in the Intelligent Mail barcode.

In other embodiments, a mail campaign identifier may be derived or decoded by the recipient's mobile device from information stored in the Intelligent Mail barcode and more specifically from the fields “mailer identifier” and “serial number. In some cases, the date of the mobile device mail scan operation may also come into play in determining a specific campaign. For example: ABCStore 4th of July campaign is identified by Mailer ID: 345590, Serial No. range: 000000001-000109999. ABCStore Mid-Summer campaign is identified by Mailer ID: 345590 Serial No. range 002000001-002109999. ABCStore Labor Day Sale is identified by Mailer ID: 345590, Serial No. range: 000000001-000109999. It should be noted that the serial number range can be repeated because this campaign is more than 45 days after the 4th of July campaign, and uniqueness is only guaranteed for a period of time such as 45 days under United States Post Office rules.

In other embodiments a mail campaign identifier may be derived from the recognition of logos, text, images or markings on the mail piece.

Other embodiments illustrate a method of a mail recipient receiving the personalized augmented reality visual data imagery or the 3D hologram from a server and displaying the content received using his or hers mobile device. Using the mobile device to process the image stream may involve operations such as sending the sender of the mail piece, the recipient of the mail piece and the mail campaign to a server to obtain the personalized content. The personalized content may include augmented reality visual data imagery or a 3D hologram that are unique to the mail piece and/or the recipient of the mail piece.

Other embodiments illustrate a method of creating the personalized augmented reality visual data imagery or the 3D hologram at the mail recipient's mobile device. Using an augmented reality or 3D hologram software application along with techniques such as text-to-speech, the mobile device can be made to generate the personalized content and display it to the mail recipient or user. The personalized content may be programmed to include augmented reality visual data imagery, a 3D hologram, voice messages and/or the like. The creation of the personalized content by the recipient's mobile device may involve operations such as processing the image stream to decode elements such as a unique barcode on the recipient's mail piece and transmitting this data to a server to obtain additional information to be used by the personal mobile device during the creation of the personalized content such as the name of the sender and/or recipient of the mail piece.

It is noted or understood that the term “mail recipient” (or “recipient”) is intended to be interpreted as the person to whom a mail item is addressed. When a mail item is received there is possibility that it may be viewed, examined or opened by someone other than to whom it is addressed. It is also possible that the mail be addressed to “occupant”. The augmented reality experience and other similar customized responses are formed based, in part, upon who is being addressed on the mail item. The customization of a viewing experience is dependent on the information that is known about the addressee and the viewing experience may not be what is desired if extended to cover the viewing of a mail item by just any person or recipient, that is, one not associated with the person or address that is addressed by (on) the mail item. The customization of the mail experience based upon the information gleaned from an image stream of the mail item which includes information about the mail item recipient (or “recipient”), and/or the mail campaign entity, is an important and required aspect e of the invention in the embodiments.

### BRIEF DESCRIPTION OF THE SEVERAL VIEWS OF THE DRAWINGS

The invention is better understood by reading the detailed description of the invention in conjunction with the accompanying drawings in which:

FIG. 1 is a generalized exemplary illustration that can be utilized as the basis for illustrating various illustrated embodiments of the present invention;

FIG. 2 illustrates in general steps of one illustrated embodiment of the invention in which a user utilizes a mobile device to capture and process, typically in real time, an image stream of a mail item, recognize various elements on the mail item and then transmit that recognized information to a server which in turn prepares personalized content, for example an augmented reality experience, for transmission to and viewing on the user's mobile device;

FIG. 3 depicts in greater detail, the operations performed by the process image stream block of FIG. 2;

FIG. 4 depicts in greater detail, the operations performed by the receive personalized content block of FIG. 2;

FIG. 5 depicts overall processing in one illustrated embodiment of the present invention;

FIG. 6 depicts processing of image stream to retrieve identifying information from a mail piece in steps of a method in which an image stream is captured by a digital camera apparatus and processed at block by computing apparatus controlled by an application program on a mobile device such as a smart cell phone or tablet; and,

FIG. 7 depicts processing by a computer server or on a mobile device of information captured from a received mail piece so as to create personalized content, for example creating an augmented reality visual data imagery, or creating a 3D hologram.

### DETAILED DESCRIPTION OF THE INVENTION

The following detailed description includes references to the accompanying drawings, which form a part of the detailed description. The drawings show, by way of illustration, specific embodiments in which the apparatus may be practiced. These embodiments, which may also be referred to herein as “examples” or “options” or “exemplary” are described in enough detail to enable those skilled in the art to practice the illustrated embodiments. The disclosed embodiments may be combined, other embodiments may be utilized or structural or logical changes may be made without departing from the scope of the invention. The following detailed description is, therefore, not to be taken in a limiting sense and the scope of the invention is defined by the appended claims and their legal equivalents.

Embodiments of the present invention relate to bringing mail to life by providing a personalized multi-media experience to a mail recipient by using the recipient's own a camera-enabled mobile device to acquire an image stream of a mail piece and to reproduce augmented reality visual data imagery or a 3D hologram that are unique to either the mail piece or to the recipient of the mail piece or both.

According to certain embodiments of the invention, a mail recipient or user uses a personal mobile device to acquire an image stream of a mail piece such as a letter, a postcard, a flat, a parcel and/or the like. The mobile device may be a camera-enabled cell phone, tablet, watch, Google glasses, etc.

A postcard or post card is a type of mail item of particular interest for use in low cost advertising and in certain embodiments of the present invention might be advantageous for easy acquisition of a video stream of the postcard. A postcard is typically a rectangular piece of thick paper or thin cardboard intended for writing and mailing without an envelope. There have been exceptions to this, such as wood postcards, made of thin wood, and copper postcards sold in the Copper Country of the U.S. state of Michigan. In some places, it is possible to send postcards for a lower fee than for a letter. Stamp collectors distinguish between postcards (which require a stamp) and postal cards (which have the postage pre-printed on them). While a postcard is usually printed by a private company, individual or organization, a postal card may also be issued by the relevant postal authority.

According to a specific embodiment, the recipient's personal mobile device uses a previously downloaded an augmented reality software application residing on the mobile device to reproduce or display visual data imagery that is not visible on the recipient's mail piece. The augmented reality software application uses optical character recognition, pattern recognition, field recognition, or barcode recognition algorithms or mechanisms to determine from the image stream, the identities of the sender of the mail piece, the recipient of the mail piece and the mail campaign entity. The software application causes the recipient's mobile device to transmit to a server, information that identifies the sender of the mail piece, the recipient of the mail piece and the mail campaign entity. The software application enables the recipient's mobile device to receive from the server, augmented reality visual data imagery that is unique to either the mail piece or to the recipient of the mail piece or both. The software application causes the recipient's mobile device to display or reproduce the personalized visual data imagery.

According to a specific embodiment, the recipient's mobile device uses a previously downloaded 3D hologram software application residing on the mobile device that causes the device to reproduce or display a 3D hologram. The 3D hologram software application uses optical character recognition, pattern recognition, field recognition, or barcode recognition techniques or mechanisms that determine or decode from the generated image stream, the sender of the mail piece, the recipient of the mail piece and the mail campaign entity. The software application causes the recipient's mobile device to transmit to a server, information identifying the sender of the mail piece, the recipient of the mail piece and the mail campaign entity. The software application enables the recipient's mobile device to receive from the server, a 3D hologram that is unique to the mail piece or to the recipient of the mail piece or both. The software application causes the mobile device to reproduce or display the personalized 3D hologram to the recipient.

According to a further specific embodiment, the recipient's mobile device uses a previously downloaded software application residing on the mobile device to generate the personalized content and display it to the recipient or user. The personalized content includes augmented reality visual data imagery, 3D holograms, voice messages and/or the like. The creation of the personalized content by the recipient's mobile device may involve operations such as processing the image stream produced by the recipient and decoding elements such as a unique barcode (IMB) on the mail piece and then transmitting this data to a server which it uses to obtain additional information to be used by the mobile device during the recipient's creation of the personalized content such as the name of the sender and/or recipient of the mail piece. The creation of the personalized content by the recipient on the mobile device may involve using techniques such as text-to-speech.

According to another specific embodiment, the recipient's mobile device is programmed to save the personalized content to be viewed by the recipient or user at a later time. Saving the personalized content may include the mobile device performing operations such as storing the content in the device's memory or transmitting the content to a server and creating a link to the content in the mobile device so that it can be retrieved by the recipient or user at a later time.

According to another specific embodiment, information can be taken from the recipient's mobile device and sent to a server so as to establish a relationship between the mail item, or the mail item recipient, or the mail campaign, or the mail item sender and the information taken (gleaned) from the recipient's mobile device. For example, further mobile device data such as the mobile device identifier or phone number, if the mobile device is a cell phone, could, in further embodiments of the present invention, be included in data sent to the server so as to store and preserve that further mobile device data for use in future mail campaigns, or even for future advertising that may or not just be through the mail. The contact phone number and name list or addresses, or email addresses could, in a further embodiment, be optionally gleaned from the mobile device by the application program and sent so as to provide for storage of data on the server (or sent to another server) for future advertising or other uses.

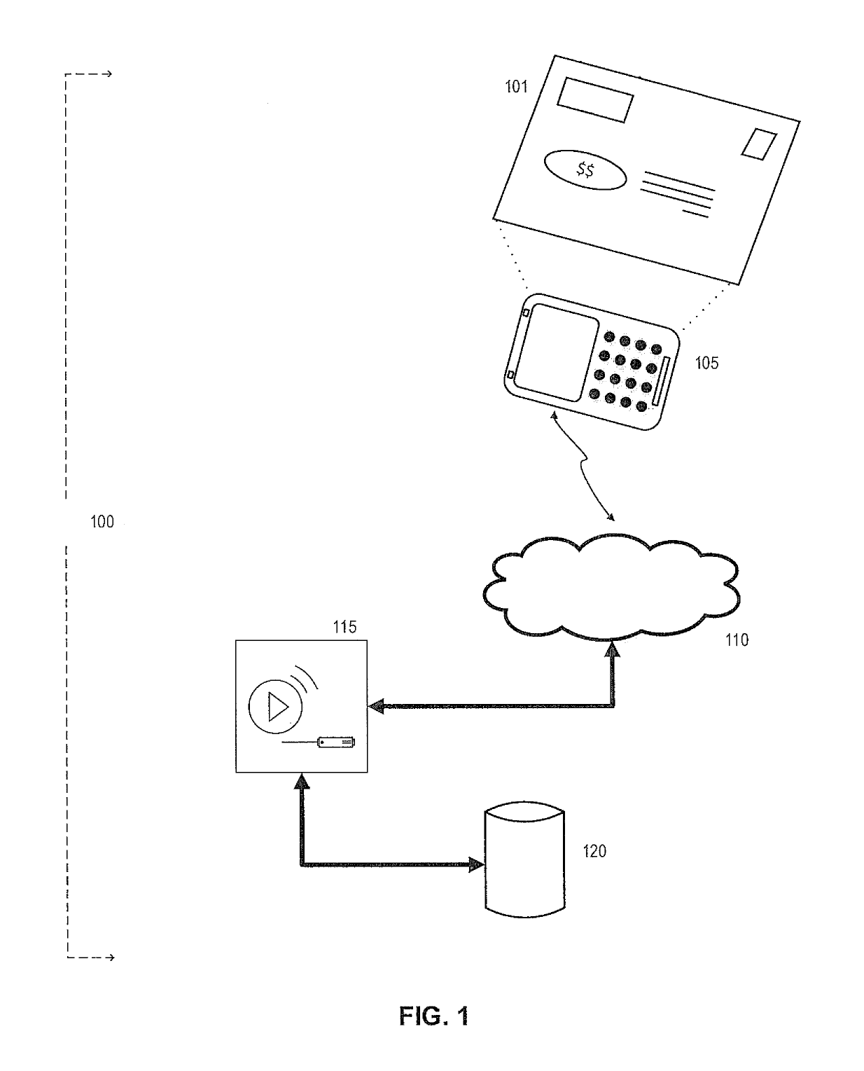

FIG. 1 depicts an exemplary system 100 within which the different embodiments of the present invention may be incorporated or implemented. As shown, the system 100 includes a personal mobile device 105 programmed or configured to enable a mail recipient to capture an image stream produced by taking as a series of snapshots or a video or capturing an image stream of a mail piece 101 or saving an image stream of a mail piece and then processing the saved imaged stream. As indicated, the surface of the mail piece may include one or more areas that include in digital form, or can be processed to determine such information as: sender information, recipient information, mail campaign information, a “picture” or other such elements as are typical on a post card or mail item. The mobile device 105 may be a camera-enabled phone, tablet, watch, Google glasses, etc.

The recipient's mobile device 105 can be configured or programmed to process the image stream to determine the sender of the mail piece, the recipient of the mail piece and the mail campaign entity. For example, the recipient's mobile device may be programmed to perform optical character recognition (OCR), and/or pattern recognition, and/or field recognition, and/or barcode recognition operations on the image stream to determine the sender, the recipient and the mail campaign entity.

The recipient's mobile device 105 can also be configured or programmed to transmit to a server 115 over the Internet 110, information identifying the sender of the mail piece, the recipient of the mail piece and the mail campaign entity. The server 115 can be configured to receive information identifying the sender, the recipient, and the mail campaign and use it to obtain from data storage 120, the recipient's corresponding personalized content and to transmit this content back to the recipient's mobile device 105 over the Internet 110.

The recipient's mobile device 105 can also be configured or programmed to transmit to a server 115 over the Internet 110, the contents of a unique barcode that was detected or determined during the processing of the recipient's image stream. The server 115 can be configured to receive the contents of the unique barcode and use it to obtain from a data storage 120, information corresponding to that barcode such as the name of the sender and/or the name of the recipient of the mail piece and to transmit that information back to the recipient's mobile device 105 over the Internet 110. The recipient's mobile device 105 can also be programmed or configured to receive from a server 115 over the Internet 110, the personalized content and to reproduce or display this content on the recipient's mobile device 105. The recipient's mobile device 105 can also be programmed or configured to receive from a server 115 over the Internet 110, information such as the name of the sender and/or the name of the recipient which the recipient can use during the creation of the personalized content.

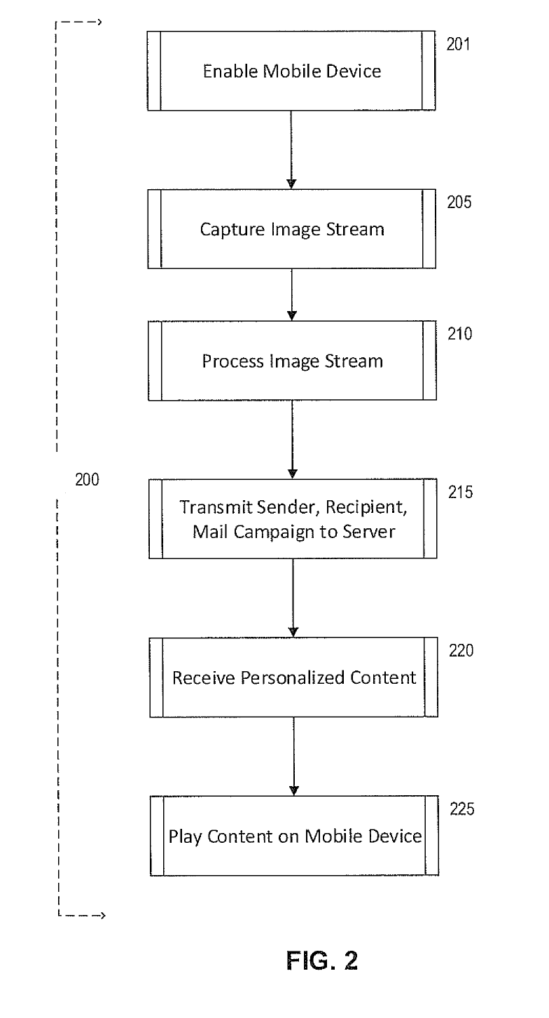

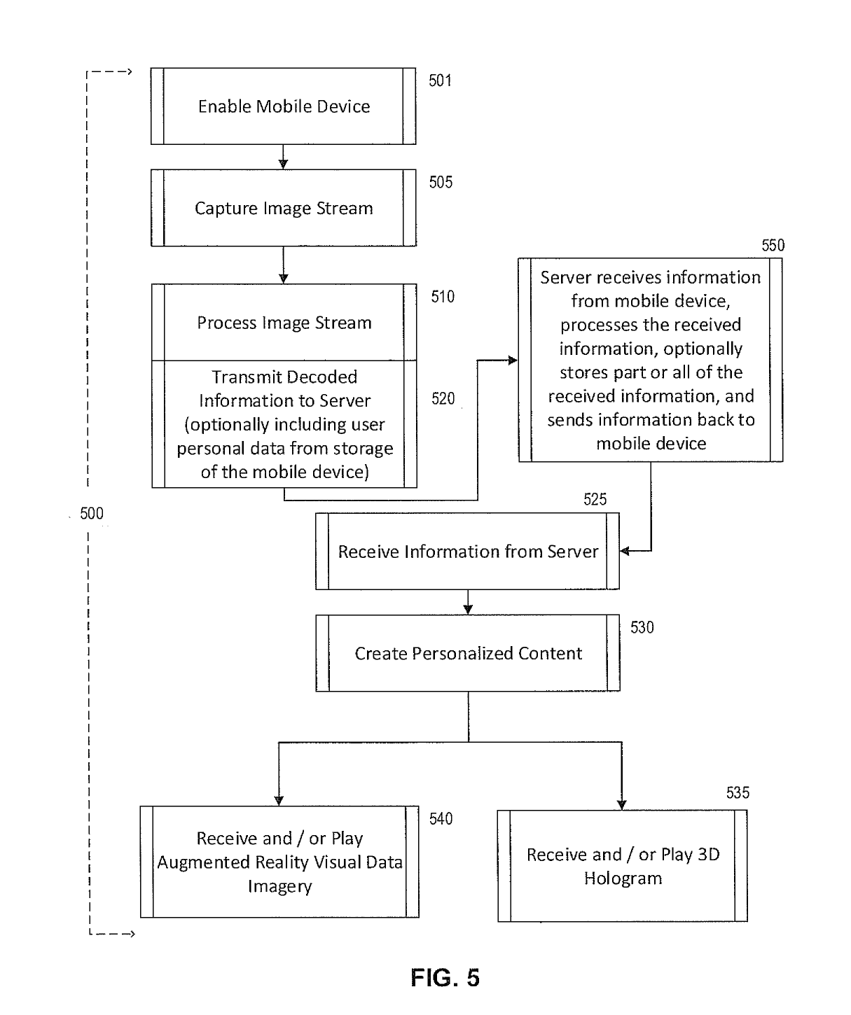

FIG. 2 depicts the operations performed by an exemplary method 200 implemented according to the teachings of the present invention. The method 200 can be implemented or incorporated in the system 100 of FIG. 1 or another appropriate system. As shown, the method 200 begins at block 201, at which location a user or mail recipient enables a personal mobile device (e.g. mobile device 105 of FIG. 5). The enabling the mobile device 105 operation of block 201 may involve performing any one of a number of activities. For example, enabling the recipient's mobile device 105 may involve the recipient downloading a software application, executing the application, aiming the mobile device at the mail piece, and/or the like. At block 205, the recipient uses the personal mobile device 105 to capture an image stream. This can take many forms, but typically involves the recipient capturing a series of electronic images as a video or a series of snapshots of the entire surface of the mail piece 101. At block 210, the captured image stream is processed or decoded by the recipient's mobile device 105 to determine or identify the sender of the mail piece, the recipient of the mail piece and the mail campaign entity if applicable. This process can take many forms, but typically involves the use of optical character recognition (OCR), pattern recognition, field recognition, barcode recognition, or a combination of any of those techniques. At block 215, after the sender of the mail piece, the recipient of the mail piece and the mail campaign entity or organization have been determined or identified in block 210, the recipient's mobile device 105 transmits this information to a server (e.g. server 115 of FIG. 1). The server 115 uses the information to obtain the personalized content for the mail piece and transmits it back to the recipient's mobile device 105. At block 220, the recipient's mobile device 105 receives from the server, the personalized content. The content received can include augmented reality visual data imagery, a 3D hologram, and/or the like. At block 225, the recipient's mobile device 105 uses the personalized content received from the server in block 220 to provide or create a personalized multi-media experience to the user. This can include displaying on the recipient's mobile device 105, the augmented reality visual data imagery, displaying a 3D hologram, and/or the like.

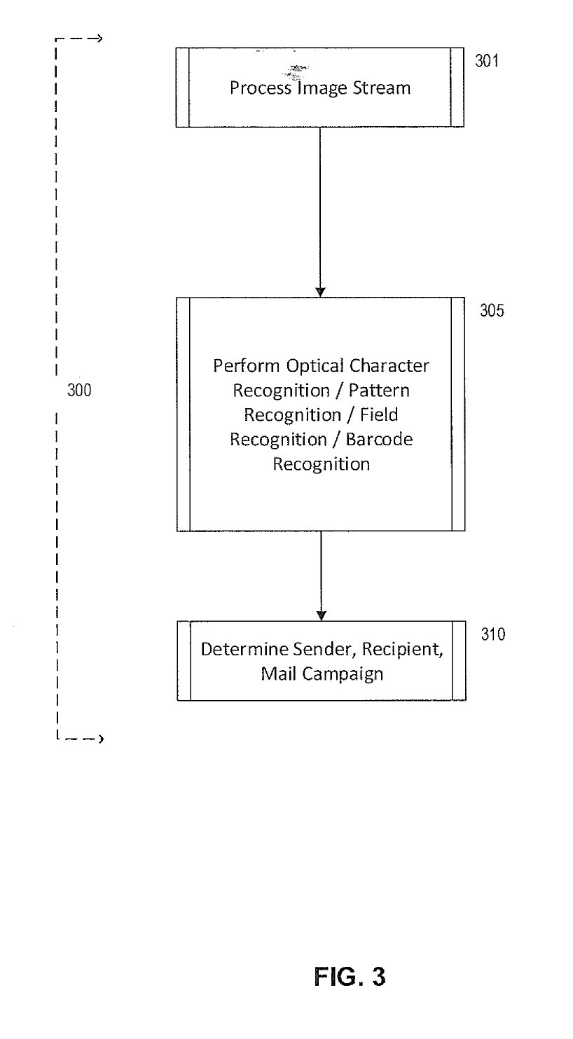

FIG. 3 depicts in greater detail, the operations performed by the process image stream block 210 of FIG. 2. In this instance, the image processing is performed by the recipient's mobile device 105 using a software engine incorporated into the device 105. The engine receives the image stream at block 301. Using, for example, a previously-downloaded software application, at block 305, the engine performs optical character recognition (OCR), pattern recognition, field recognition, barcode recognition, or a combination of any of those techniques to determine or identify, at block 310, the sender of the mail piece, the recipient of the mail piece and the mail campaign entity, if applicable.

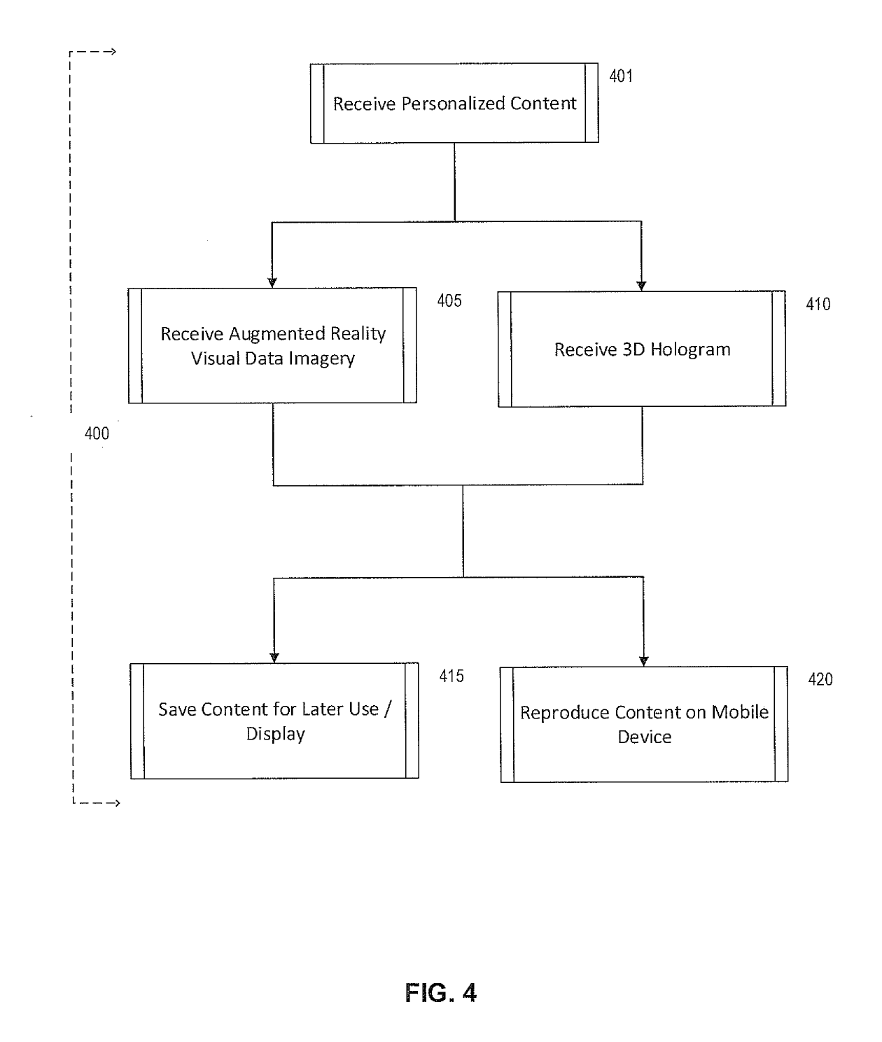

FIG. 4 depicts in greater detail, the operations performed by the receive personalized content block 220 of FIG. 2. In this instance, the recipient's mobile device 105 receives the personalized content from the server 115 enabled by a software engine incorporated into the device 105. The mobile device software engine receives the personalized content at block 401. Using, for example, a recipient's previously-downloaded software application, at block 405, the mobile device 105 software engine is enabled to receive augmented reality visual data imagery. Using, as another example, another previously-downloaded software application, at block 410, the mobile device 105 software engine is enabled to receive a 3D hologram. After the mobile device 105 software engine has received the personalized content from the server 115, the mobile device 105, at block 415, uses this content to deliver a personalized multi-media experience to the mail recipient. This may include displaying the augmented reality visual data imagery, displaying a 3D hologram, and/or the like, on the recipient's mobile device 105.

FIG. 5 depicts overall processing 500 in one illustrated embodiment of the present invention. First, the mobile device is enabled 501 and a digital camera apparatus of the mobile device is utilized to capture an image stream 505 of a mail piece received by a mail item recipient. The image stream 505 is processed 510 by computing apparatus of the mobile device 105 in order to decode or recognized mail item recipient identification data and/or mail item sender identification data. This data is transmitted 520 to a computer server system; the server system processes the data and transmits processed data “back” to the mobile device where it is received at block 525. The mobile device is then is utilized in block 530 under control of a customized computer program to create personalized content which can be, for example, augmented reality visual imagery, or a 3D hologram. The server in certain further embodiments of the present invention may also optionally store the user personal data on the server, or send it to another server, for later use such as in future mail based advertising, or in non-mail based advertising. The augmented reality data is received and reproduced at block 540 by the mobile device, or the 3D hologram is received at block 535 by the mobile device 105 on a display apparatus of the mobile device.

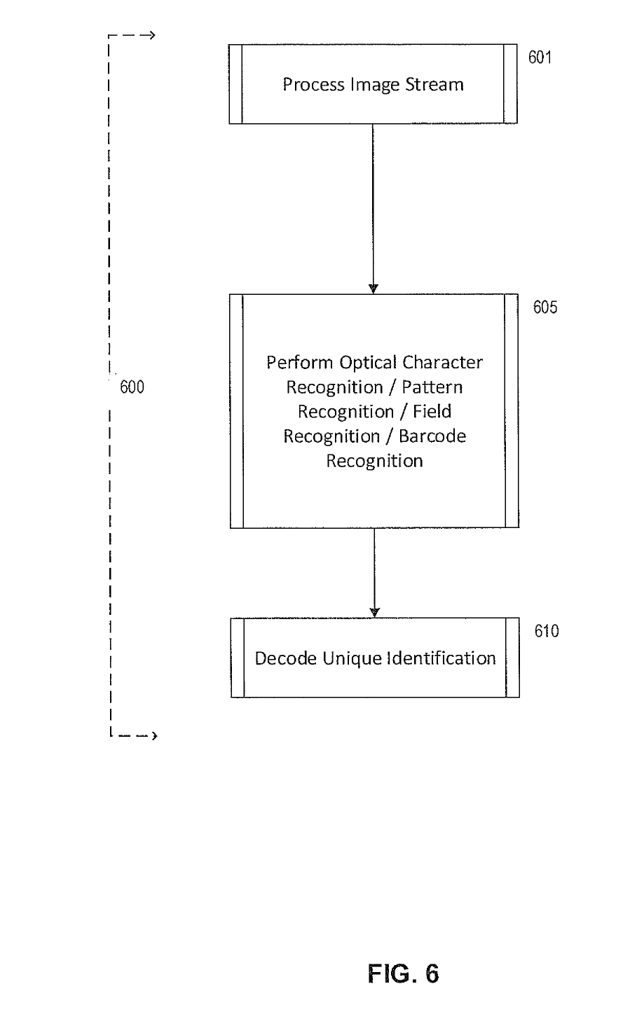

FIG. 6 depicts processing of image stream to retrieve identifying information from a mail piece in steps of a method 600 in which an image stream is captured by a digital camera apparatus and processed at block 601 by computing apparatus controlled by an application program on a mobile device such as a smart cell phone or tablet. Under control of the application program the computing apparatus of the mobile device performs 605 optical character recognition, or pattern recognition, or specific field recognition from the mail piece, or barcode recognition such as decoding of the Intelligent Mail Barcode to determine identification information 610 such as unique sender information and/unique recipient information or mail campaign identification data.

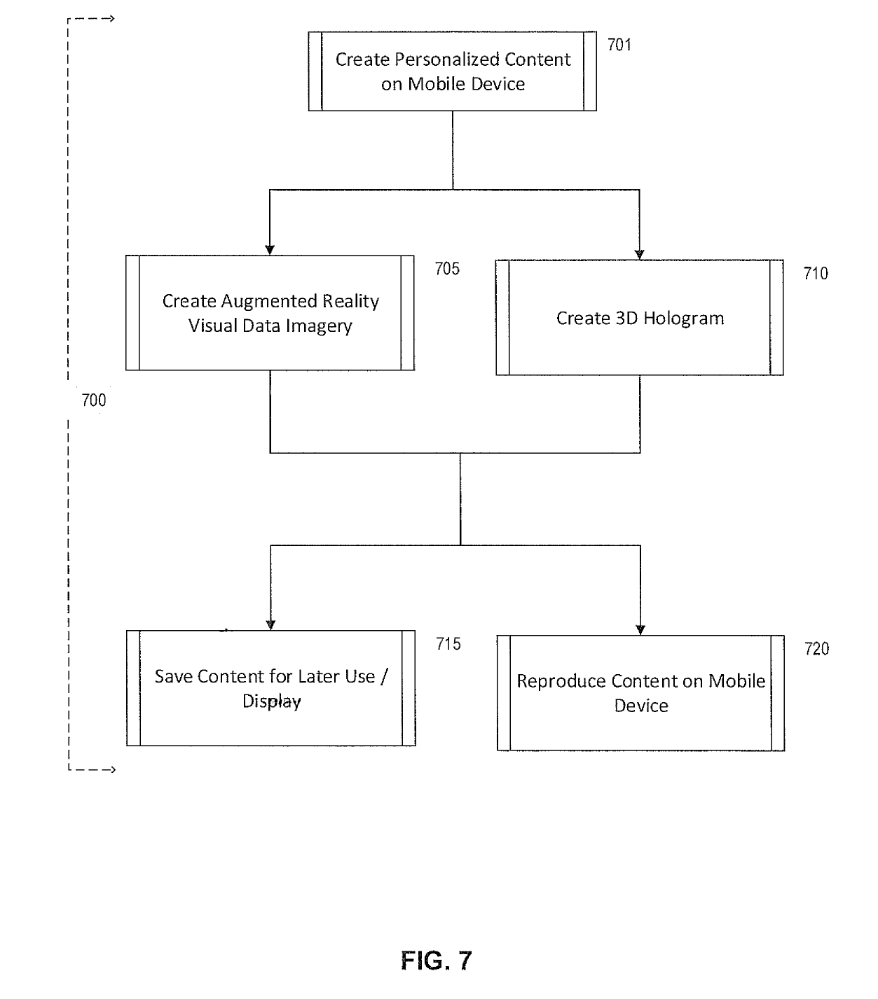

FIG. 7 depicts processing 700 by a computer server or on a mobile device of information captured from a received mail piece so as to create personalized content 701, for example creating an augmented reality visual data imagery 705, or creating a 3D hologram 710. The created content can be saved in storage of the mobile device for later use or display by a digital display apparatus of the mobile device 715, or reproduced immediately 720 by the digital display apparatus of the mobile device.

It is to be understood that the above description is intended to be illustrative, and not restrictive. Other embodiments will be apparent to those of skill in the art upon reading and understanding the above description. It should be noted that embodiments discussed in different portions of the description or referred to in different drawings can be combined to form additional embodiments of the present application. The scope should, therefore, be determined with reference to the appended claims, along with the full scope of equivalents to which such claims are entitled.

What is claimed is:

1. A method of bringing physical mail to life by providing a personalized multi-media experience to a mail recipient on a mail recipient's personal mobile device, the mobile device incorporating: a) a display apparatus, b) a digital camera apparatus, c) a digital computing apparatus, and d) wireless digital communication apparatus, the method comprising the steps of:
A) a mail recipient acquiring or producing using the digital camera of the mobile device, a mail item image stream of a received mail piece;
B) processing, by the digital computing apparatus of the mobile device, the mail item image stream of the mail piece to determine or decode mail piece data, the mail piece data comprising a) identified sender data of the mail piece, and b) identified recipient data of the mail piece;
C) transmitting by the wireless digital communication apparatus of the mobile device, the mail piece data to a computer server system;
D) receiving by the wireless digital communication apparatus of the mobile device from the computer server system, augmented reality visual data imagery, the augmented reality visual data imagery generated by the computer server system and based on both a) the identified sender data of the recipient mail piece, and b) the identified recipient data of the mail piece; and,
E) displaying, by the display apparatus of the mobile device, the augmented reality visual data imagery.

2. The method of claim 1 wherein the mail piece data further comprises a mobile device identifier.

3. The method of claim 2 wherein the mobile device is a cellular phone device and the mobile device identifier is a phone number associated with the cellular phone device.

4. The method of claim 1 wherein the identified sender data of the mail piece comprises a mail campaign identifier.

5. A method of bringing received mail postcard to life by providing a personalized multi-media experience to a mail recipient on a mail recipient's personal mobile device, the mobile device incorporating: a) a display apparatus, b) a digital camera apparatus, c) a digital computing apparatus, and d) wireless digital communication apparatus, the method comprising the steps of:
A) the recipient acquiring or producing using the digital camera, a mail item image stream of the received mail postcard;
B) processing the mail item image stream of the recipient received mail postcard to determine: a) identified sender data of the received mail postcard, and b) identified recipient data of the received mail postcard;
C) displaying, on the display apparatus of the recipient's personal mobile device, augmented reality visual data imagery, the augmented reality visual data imagery generated based on both a) the identified sender data of the received mail postcard, and b) the identified recipient data of the received mail postcard.

6. A method of bringing physical mail to life by providing a personalized multi-media experience to a recipient on a mail recipient's mobile device, the mobile device incorporating: a) a display apparatus, b) a digital camera apparatus, c) a digital computing apparatus, and d) wireless digital communication apparatus, the method comprising the steps of:
A) a recipient acquiring or producing, using the digital camera of the mobile device, a mail item image stream of a mail piece;
B) processing the mail item image stream of the mail piece to determine: a) identified sender data of the mail piece, and b) identified recipient data of the mail piece;
C) displaying to the mail recipient, on the display apparatus of the recipient personal mobile device, augmented reality visual data imagery, the augmented reality visual data imagery generated based on both a) the identified sender data of the mail piece, and b) the identified recipient data of the mail piece.

7. The method of claim 6 wherein the identified sender data of the mail piece comprises a mail campaign entity identifier.

8. A method of bringing physical mail to life to a mail recipient by providing a personalized multi-media experience on a mail recipient's mobile device, the mobile device incorporating: a) a display apparatus, b) digital camera apparatus, c) digital computing apparatus, and d) wireless digital communication apparatus, the method comprising the steps of:
A) the mail recipient acquiring or producing, using the digital camera of the recipient personal mobile device, a mail item image stream of a mail piece;
B) processing the mail item image stream of the mail piece to determine: a) identified sender data of the mail piece, and b) identified recipient data of the mail piece;
C) displaying to the mail recipient, on the display apparatus of the mobile device, three-dimensional hologram imagery, the three-dimensional hologram imagery generated based on both a) the identified sender data of the mail piece, and b) the identified recipient data of the mail piece.

9. The method of claim 8 wherein the identified sender data of the mail piece comprises a mail campaign entity identifier.

10. A method of providing a mobile device application program that enables, a personalized multi-media experience to be provided to a mail recipient, the method comprising the steps of:
A) Storing in the storage of a server, the mobile device application program;
B) transmitting from the server to a mobile device, the mobile device application program, the mobile device application program enabling control of the operations of the recipient mobile device so as to bring physical mail to life and comprising performing the steps of:
a) enabling a mail recipient to acquire or produce, with a digital camera of the mobile device, a mail item image stream of a mail piece;
b) enabling processing the mail item image stream of the mail piece to determine: a) identified sender data of the mail piece, and b) identified recipient data of the mail piece; and,
c) enabling displaying, utilizing a display apparatus of the mobile device, augmented reality visual data imagery, the augmented reality visual data imagery generated based on both a) the identified sender data of the mail piece, and b) the identified recipient data of the mail piece.

11. A non-transitory computer readable medium storing a program for enabling or causing a mobile device to perform the steps of:
A) enabling a mail recipient for acquiring or producing, with a digital camera of the mobile device, a mail item image stream of a mail piece;
B) enabling processing the mail item image stream of the mail piece to determine: a) an identified sender data of the mail piece, and b) an identified recipient data of the mail piece; and
C) enabling displaying, utilizing a display apparatus of the mobile device, augmented reality visual data imagery, the augmented reality visual data imagery generated based on both a) the identified sender data of the mail piece, and b) the identified recipient data of the mail piece.

12. A method of bringing physical mail to life by providing a personalized multi-media experience to a mail item recipient of a mail piece on the mail recipient's personal mobile device, the personal mobile device incorporating: a) a display apparatus, b) a digital camera apparatus, c) a digital computing apparatus, and d) wireless digital communication apparatus, the method comprising the steps of:
A) receiving mail piece data on a computer server, the mail piece data sent from a mobile device application program running on the mail item recipient's personal mobile device, the mail piece data acquired or produced using the digital camera of the mobile device to capture a mail piece image stream of the received mail piece and then processing, by the digital computing apparatus of the mobile device, the mail piece image stream to determine or decode the mail piece data, the mail piece data comprising a) identified sender data of the mail piece, and b) identified recipient data of the mail piece;
B) generating, on the computer server, augmented reality visual data imagery, the augmented reality visual data imagery generated by the computer server system and based on both a) the identified sender data of the recipient mail piece, and b) the identified recipient data of the mail piece; and,
C) sending by the computer server to the mail recipient's personal mobile device, the augmented reality visual data imagery for display by the display apparatus of the mobile device.

13. The method of claim 12 further including the step of:
D) storing on the computer server, for later reference after completion of steps B and C, information identifying the personal mobile device or identification information from the mobile device.

14. The method of claim 12 further including the step of:
D) storing on the computer server, for later reference after completion of steps B and C, information identifying friends or contact list information from the mobile device.

15. A method of bringing physical mail to life by providing a personalized multi-media experience to a mail item recipient of a mail piece on the mail recipient's personal mobile device, the personal mobile device incorporating: a) a display apparatus, b) a digital camera apparatus, c) a digital computing apparatus, and d) wireless digital communication apparatus, the method comprising the steps of:
A) receiving mail piece data on a computer server, the mail piece data sent from a mobile device application program running on the mail item recipient's personal mobile device, the mail piece data acquired or produced using the digital camera of the mobile device to capture a mail piece image stream of the received mail piece and then processing, by the digital computing apparatus of the mobile device, the mail item image stream to locate and decode an Intelligent Mail Barcode of the mail piece to determine the mail piece data, the mail piece data comprising a) identified sender data of the mail piece, and b) identified recipient data of the mail piece;
B) generating, on the computer server, augmented reality visual data imagery, the augmented reality visual data imagery generated by the computer server system and based on both a) the identified sender data of the recipient mail piece, and b) the identified recipient data of the mail piece; and,
C) sending by the computer server to the mail recipient's personal mobile device, the augmented reality visual data imagery for display by the display apparatus of the mobile device.

16. A method of bringing physical mail to life by providing a personalized multi-media experience to a mail recipient on a mail recipient's personal mobile device, the mobile device incorporating: a) a display apparatus, b) a digital camera apparatus, c) a digital computing apparatus, and d) wireless digital communication apparatus, the method comprising the steps of:
A) a mail recipient acquiring or producing using the digital camera of the mobile device, a mail item image stream of a received mail piece;
B) processing, by the digital computing apparatus of the mobile device, the mail item image stream of the mail piece to determine or decode mail piece data, the mail piece data comprising a) identified sender data of the mail piece, and b) identified recipient data of the mail piece;
D) processing, by the digital computing apparatus of the mobile device, and generating augmented reality visual data imagery, the augmented reality visual data imagery based on both a) the identified sender data of the recipient mail piece, and b) the identified recipient data of the mail piece; and,
E) displaying, by the display apparatus of the mobile device, the augmented reality visual data imagery.
